(19) United States
(12) Patent Application Publication
(10) Pub. No.: US 2025/0052950 A1
(43) Pub. Date: Feb. 13, 2025

(54) Optical Coupling Structure

(71) Applicant: LiGenTec SA, Ecublens (CH)

(72) Inventors: Davide Sacchetto, Ecublens (CH); Mariam Benelfaquih, Ecublens (CH)

(73) Assignee: LiGenTec SA, Ecublens (CH)

(21) Appl. No.: 18/710,969

(22) PCT Filed: Nov. 22, 2022
(86) PCT No.: PCT/EP2022/082835

§ 371 Date: May 16, 2024

(30) Foreign Application Priority Data
Nov. 23, 2021 (GB) 2116865.3

(51) Int. Cl. G02B 6/12; G02B 6/122

(52) U.S. Cl. CPC G02B 6/12002; G02B 6/12004; G02B 6/1228; G02B 2006/1204; G02B 2006/12045; G02B 2006/12047; G02B 2006/12061; G02B 2006/12069; G02B 2006/12078; G02B 2006/12085; G02B 2006/12123; G02B 2006/12142; G02B 2006/12147

(57) ABSTRACT

A coupling structure is presented, which comprises: a waveguide core layer supporting a guided mode and an active layer disposed above the waveguide core layer. In the coupling region, the guided mode is coupled to the active layer, and the active layer outside the coupling region is angled with respect to the active layer in the coupling region such that a distance between the waveguide core layer and the active layer gradually increases away from the coupling region.

### TECHNICAL FIELD

This specification relates to fabrication of photonic integrated circuits.

### BACKGROUND

In typical electro-optical photonic devices based on waveguides, such as modulators or photodiodes, the active part, for example, electro-optically active part for electro-optical modulators, directly forms part of a waveguide structure. This is because active photonic platforms, such as silicon-on-insulators or InP are based on semiconductors which can be used both to guide light or to manipulate light via charge carriers.

Such structures are not feasible for non-semiconductor based platforms, such as glass or silicon nitride. Therefore, a light coupling structure is needed between the non-semiconductor based waveguides and active semiconductor components, such as Si or InP. The light coupling structure usually exploits lateral tapering or heterogeneous die bonding. However, such solutions are very sensitive to fabrication tolerances and lead to large scattering losses.

### SUMMARY

According to an aspect of the present invention, there is provided a coupling structure. The coupling structure includes a waveguide core layer supporting a guided mode and an active layer disposed above the waveguide core layer. In the coupling region, the guided mode is coupled to the active layer. The active layer outside the coupling region is angled with respect to the active layer in the coupling region such that a distance between the waveguide core layer and the active layer gradually increases away from the coupling region.

In some implementations, the coupling structure further includes a coupling layer disposed on the waveguide core layer and below the active layer.

In some implementations, in the coupling region, a thickness of the coupling layer is such that the guided mode is evanescently coupled to the active layer.

In some implementations, a bottom surface of the coupling layer is in contact with the waveguide core layer, and in the coupling region, a top surface of the coupling layer is in contact with the active layer.

In some implementations, in the coupling region, the waveguide layer and the active layer are coupled such that the guided mode is supported by the active layer in the coupling region and the guided mode is supported by the waveguide core layer outside the coupling region.

In some implementations, in the coupling region, a width of the waveguide layer is tapered down towards a centre of the coupling region.

In some implementations, the waveguide core layer comprises an in-coupling layer, an out-coupling layer and a gap between the in-coupling layer and the out-coupling layer. The gap is in the coupling region. The guided mode is coupled to the active layer above the gap in the coupling region.

In some implementations, the out-coupling layer and the active layer are arranged such that the guided mode in the coupling region in the active layer is coupled to the out-coupling layer.

In some implementations, the out-coupling layer and the active layer are arranged such that at least part of the guided mode in the coupling region in the active layer is coupled to the active layer outside the coupling region.

In some implementations, the active layer outside the coupling region is at a first angle with respect to the active layer in the coupling region, and the first angle is less than 30 degrees.

In some implementations, the active layer is configured as a photodiode for detecting the guided mode supported by the waveguide core layer.

In some implementations, the active layer is configured as an electro-optic modulator for modulating amplitude and/or phase of the guided mode supported by the waveguide core layer.

In some implementations, the active layer comprises an electro-optic material, such as LiNbO₃, BaTiO₃, LiTaO₃, KTP, BBO or an electro-optic polymer.

In some implementations, the active layer comprises a semiconductor, such as Si, Ge, InP, GaAs, InGaAs, InAlGaAs and combinations thereof.

In some implementations, the coupling structure further includes a top layer disposed on the coupling layer outside the coupling region, forming a slope towards the coupling region. The active layer is disposed on the top layer outside the coupling region such and on the coupling layer in the coupling region.

### BRIEF DESCRIPTION OF THE DRAWINGS

Certain embodiments of the present invention will now be described, by way of examples, with reference to the accompanying drawings, in which:

FIG. 1 is a schematic that illustrates vertical coupling structure.

FIG. 2a is a schematic that illustrates an exemplary embodiment of a vertical coupling structure.

FIG. 2b is a schematic that illustrates an exemplary embodiment of a vertical coupling structure for evanescent interaction.

FIG. 2c is a schematic that illustrates an exemplary embodiment of a vertical coupling structure for transferred interaction.

FIG. 3 shows a simulation result of coupling efficiency.

### DETAILED DESCRIPTION

This specification discloses a vertical coupling structure to decrease the scattering losses between a dielectric waveguide and active components integrated on the same platform. The layer for the active components approach the layer for the dielectric waveguide at a vertical angle. This allows for optical coupling while minimizing scattering losses.

In this specification, two types of active devices are considered: an electro-optic modulator or EO modulator and a photodiode or a photodetector.

An electro-optic modulator is an optical device in which physical properties of a beam of light or a guided mode of light are modulated in response to an electric signal. Examples of physical properties of light include phase, amplitude or polarization.

The charge density within silicon devices can be manipulated with an electric field via carrier injection, accumulation or depletion. Therefore, the modulation of phase and amplitude of light can be achieved with silicon devices via the plasma dispersion effect.

In this specification, the term ‘electro-optic modulator’ will be understood to encompass all of the mechanisms to induce the modulation of phase, amplitude or polarization of light in response to an electric field such the electro-optic effect and the plasma dispersion effect, and other possible mechanisms. Therefore, the term “electro-optic modulator” in this specification is used to mean any optical device in which a beam of light or a guided mode of light are modulated in response to an electric signal.

A photodetector is a semiconductor device which converts light into an electric current. The current is generated when the light is absorbed by the semiconductor device. Therefore, in order to improve the photodetection efficiency, the interaction between the light and the semiconductor device can be maximised. On photonic integrated circuits, the semiconductor part of the photodiode can be made into a waveguide form such that the light to be detected is guided by the semiconductor waveguide to maximise the interaction, thereby maximising the detection efficiency. In this case the waveguide forming the photodiode can be evanescently coupled to a waveguide forming the photonic circuits.

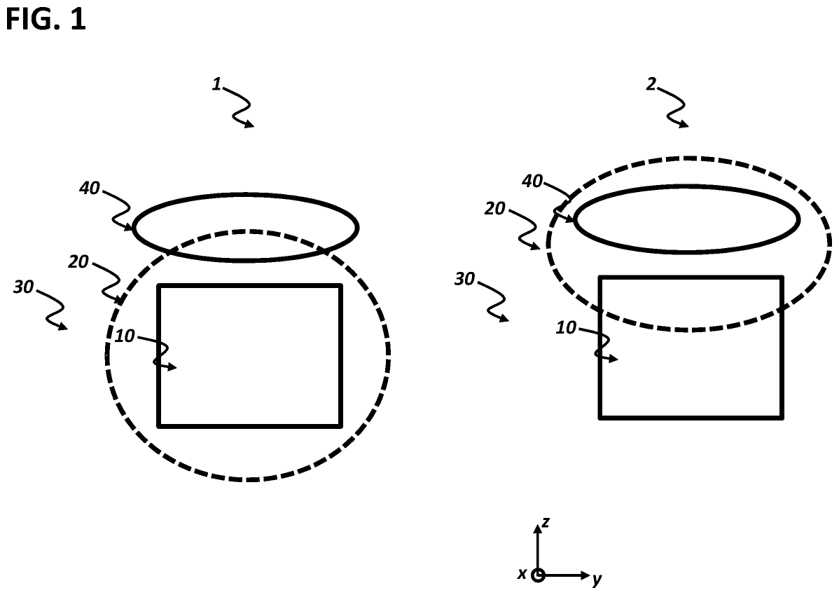

FIG. 1 is a schematic that illustrates vertical coupling structure.

FIG. 1 shows a cross-section view of a waveguide including a core 10 and the active device 40, such as an EO modulator or a photodetector. The core 10 and the active device 40 are embedded within or at least in contact with a surrounding material 30.

The waveguide may be formed by the core 10 and a cladding, where at least part of the cladding may be formed by the surrounding material 30.

The core 10 has a different refractive index than the surrounding material 30 such that it supports a guided mode 20. Equivalently, the region around the centre of the guided mode 20 with a different refractive index than the surrounding material 30 may be regarded as the core 10. The shape of the cross-section the core 10 in the yz-plane is shown to be a square shape in the example of FIG. 1. However, the shape of the cross-section of the core 10 is not limited to a square shape. In some implementations, the shape of the cross-section of the core 10 may be of a polygonal shape.

The guided mode 20 may reside in the core 10 and the cladding. In some implementations, one or more surface of the core 10 may be in contact with the cladding. In some implementations, the core 10 may be wholly embedded within a cladding. As long as the core 10 supports the guided mode 20 to propagate along the core 10, the configuration of the waveguide is not limited to these examples.

In some implementations, the surrounding material 30 around the core 10 forming the cladding of the waveguide may be uniform throughout the transverse profile of the mode 20.

In some implementations, the surrounding material 30 around the core 10 forming the cladding of the waveguide may include one or more further interfaces at which the refractive index changes such that the transverse profile of the guided mode 20 may extend beyond that one or more interfaces within the surrounding material 30.

In some implementations, the core 10 may be embedded in the surrounding material 30 without any of the surfaces exposed to air or vacuum.

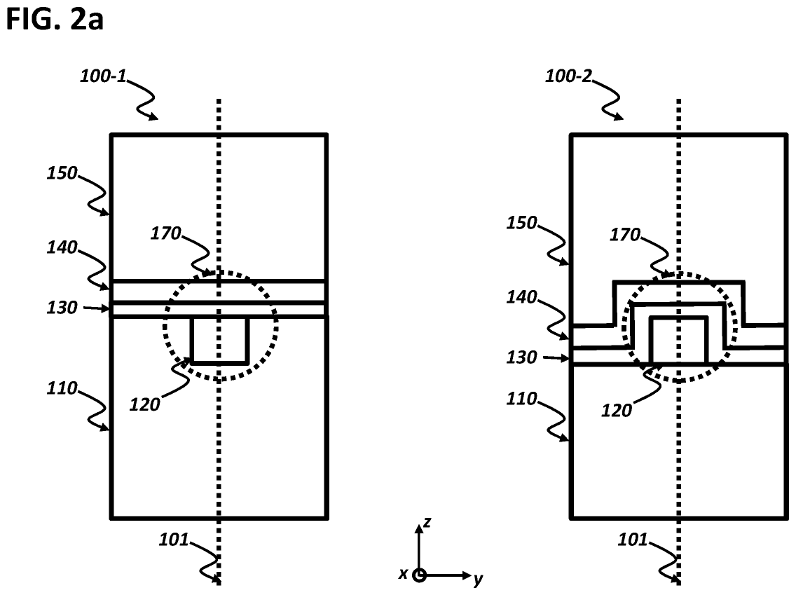

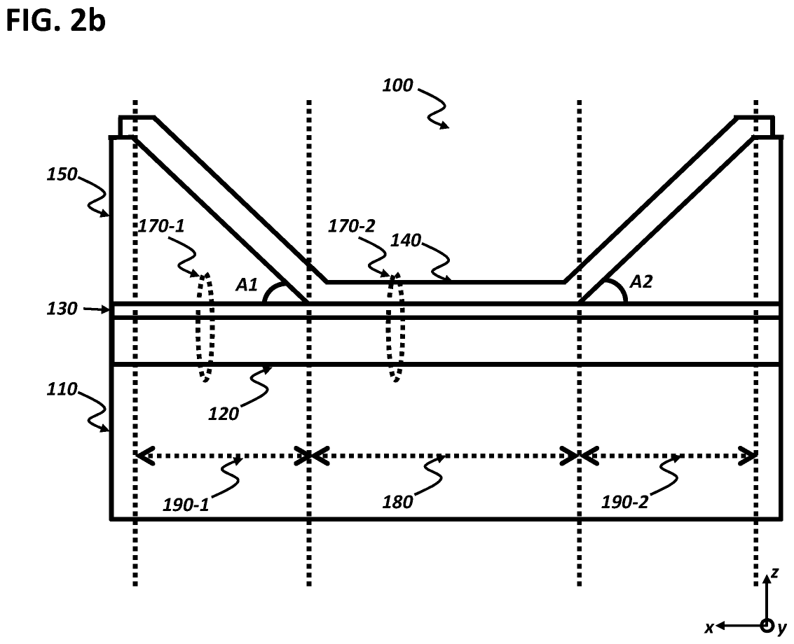

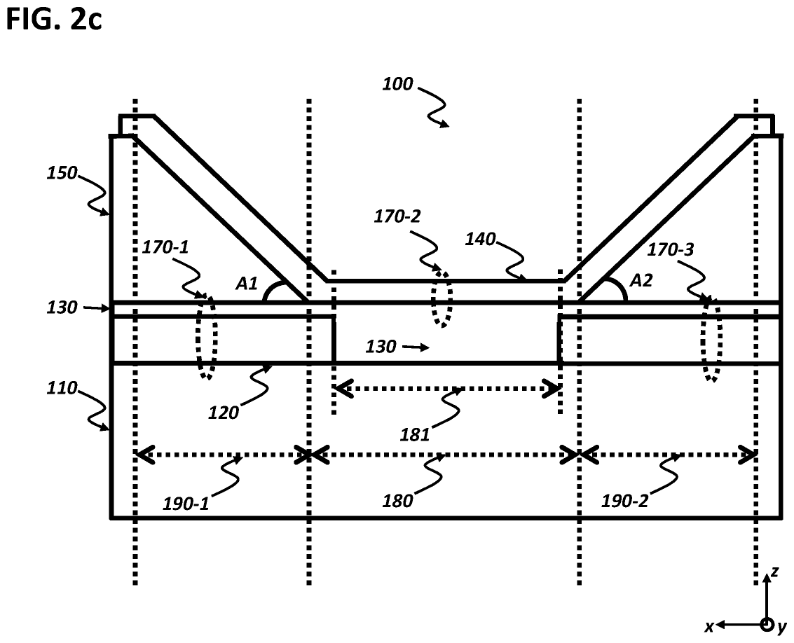

In some implementations, at least one surface of the core 10 may be exposed to air or vacuum. For example, for a rib waveguide formed with the core 10, at least one surface is completely exposed to air or vacuum without being covered with the surrounding material 30. In this case, the cladding may be formed by the surrounding material 30 in contact with the core 10 and the space around the exposed part of the core 10, which may be air or vacuum. This implementation will be discussed in more detail in FIG. 2.

The guided mode 20 travels in the x-direction, namely in a perpendicular direction to the cross section of the core 10, guided by the waveguide formed by the core 10 and the cladding material around the core formed within the surrounding material 30.

The transverse mode profile, namely the power or intensity distribution of the guided mode 20 in the yz-plane, parallel to the cross section of the core 10, resides substantially within the cross-section of the core 10 but extends beyond the boundary defined by the cross-section of the core 10 in the yz-plane.

FIG. 1 shows a left panel 1, which shows the case of an evanescent interaction, where the electro-optic modulation or the photodetection is performed with the guided mode 20 guided by and confined around the waveguide formed by the core 10 and the surrounding material 30. In this case, the active device 40 does not need to support the guided mode 20. FIG. 1 also shows a right panel 2, which shows the case of the transferred interaction, where the guided mode 20 transferred to the active device 40 for electro-optical modulation or photodetection. In this case, the active device 40 supports the guided mode 20. The coupler described in this specification relates to both of these configurations.

In some implementations, as shown in the left panel 1, the transverse mode profile of the guided mode 20 may have the highest intensity in the centre of the core 10. In some implementations, the centre of the core 10 and the centre of the guided mode 20 may coincide and have the highest intensity within the transverse mode profile of the guided mode 20 in the yz-plane.

The overall shape of the guided mode 20 is illustrated with a dotted line as shown in FIG. 1. The dotted line depicting the guided mode 20 in FIG. 1 is a visual guide only to illustrate the approximate extent of the guided mode 20. For example, the dotted line 20 may represent a line following the same intensity, such as 1/e² of the peak intensity at the centre of the guided mode 20 for the surrounding material 30 with a uniform refractive index around the core 10. As shown in the dotted line representing the guided mode 20 in FIG. 1, at least a fraction of the power of the guided mode 20 may reside outside the core 10.

In some implementations, as shown in the left panel 1, the fraction of power residing outside the core 10 may comprise an evanescent field on the surface of the core.

The active device 40, as an EO modulator, is configured to induce attenuation and/or phase shift on the guided mode 20. This is achieved by the change of the refractive index induced in the EO modulator 40 in response to an electric field applied to the EO modulator.

In some implementations, the active device 40, as an EO modulator, is configured to induce a phase shift on the guided mode 20. This is achieved by the change of the real part of the refractive index induced in the active device 40 in response to an electric field.

In some implementations, the active device 40, as an EO modulator, is configured to induce attenuation on the guided mode 20. This is achieved by the change of the imaginary part of the refractive index induced in the active device 40 in response to an electric field.

In some implementations, the active device 40, as a photodetector, is configured to convert at least part of the light in the guided mode 20 into an electrical current. This will inevitably leads to the attenuation on the guided mode 20. This is achieved by, for example, configuring the semiconductor part of the active device 40 as a p-n junction, or a PIN junction.

In some implementations, the active device 40 may be positioned away from the centre of the guided mode 20.

In some implementations, the active device 40 may be placed outside the core 10 in case the core 10 has a different refractive index compared to the surrounding material 30.

In some implementations, when the core 10 does not exhibit a step-like refractive index change with respect to the surrounding material 30 and the refractive index changes gradually towards the centre of the guided mode 20 such that the boundary of the core 10 is not clearly defined in the yz-plane parallel to the cross-section of the core 10, the active device 40 may be placed such that the extent of the EO modulator 40 does not overlap the centre of the guided mode 20. In this case, the position of the active device 40 may be determined to provide a balance between the degree of interaction, such as the depth of modulation or photodetection efficiency, and the degree of loss.

Also in the later examples, although the core 10 and the surrounding material may be shown to have a definite boundary for explaining the concept, in practice, the change of the refractive index at these boundaries may not be stepwise and be gradual varying around the interface.

The balance between the degree of interaction and the degree of loss may be specific to each application. In other words, the degree of interaction and the degree of loss may be determined for each application. For example, a tolerable degree of loss may be specified for a certain application. Then the position of the active device 40 may be determined to maximise the operation bandwidth within the specified tolerable optical loss.

In some implementations, the waveguide may be designed such that the modification of the effective refractive index of the waveguide by the active device 40 is taken into consideration. For example, the transverse extent of the guided mode 20 with respect to the position and the material composition of the active device 40 may be determined a priori at the design stage.

In some implementations, the active device 40 may be disposed outside an interface formed within the surrounding material 30 but close enough to the core 10 to induce phase modulation of the guided mode 20. In other words, there may be an interface between the active device 40 and the core 10. For example, an interface formed within the surrounding material 30 may support an evanescent field as part of the guided mode 20 and the active device 40 may be positioned such that the active device 40 interacts with the evanescent field of the guided mode 20, as shown in the left panel 1. For another example, the guided mode 20 may extend beyond an interface formed within the surrounding material 30. The fraction of power of the guided mode 20 beyond that interface may be significant enough such that the active device 40 positioned beyond that interface can impart phase modulation or amplitude modulation to the guided mode 20, also as shown in the left panel 1.

In some implementations, the guided mode 20 may be transferred to the active device 40, as shown in the right panel 2, such that the electro-optic modulation or the photodetection can be performed with highest possible efficiency. In case the active device 40 is an electro-optic modulator, after the phase shift is imparted on the guided mode 20, the guided mode 20 can be transferred back to the core 10, as shown in the left panel 1.

When the refractive index of the material forming the active device 40 is different from the index of the surrounding material 30 in contact, the guided mode 30 may be modified. When the length of the active device 40, the extent in the x-direction, is finite, the guided mode may be scattered by edges of the active device 40 both in the evanescent interaction shown in the left panel 1 and in the transferred interaction shown in the right panel 2, which leads to attenuation of the guided mode 30. This specification relates to mitigating this effect.

When the refractive index of the material forming the active device 40 has an imaginary part at the operating wavelength, the inherent dissipation or absorption of the EO modulator 40 leads to the attenuation of the guided mode 20.

At a given position of the active device 40 and a given area in the yz-plane of the active device 40, the degree of interaction such as the modulation depth or the photodetection efficiency is proportional to the length of the active device 40, the extent along the length of the waveguide, namely in x-direction.

In the case of the evanescent interaction as shown in the left panel 1, a balance between loss, due to scattering or absorption, and the degree of interaction can be found by adjusting one or more of the following parameters: the position of the active device 40 with respect to the guided mode 20 in the transverse yz-plane parallel to the cross-section of the core 10, the extent of the active device 40 in x-direction perpendicular to the cross-section of the core 10, the volume of the material used for the active device 40, the shape of the cross-section of the active device 40 in the transverse yz-plane, and the refractive index of the material used for the EO modulator 40.

In the case of the transferred interaction as shown in the right panel 2, a balance between loss, due to scattering or absorption, and the degree of interaction can be found by adjusting one or more of the following parameters: the extent of the active device 40 in x-direction perpendicular to the cross-section of the core 10, the volume of the material used for the active device 40, the shape of the cross-section of the active device 40 in the transverse yz-plane, and the refractive index of the material used for the EO modulator 40.

The parameters to adjust for the balance between the loss and the depth of modulation are not limited to these. The balance between the loss and the depth of modulation may be determined for a desired operation based on the design parameters such as required depth of modulation or specification on the degree of loss per length.

The choice of the material of the core 10 of the waveguide may not have to relate to the electro-optic capability or modulation capability of the active device 40. For example, the core 10 of the waveguide may be constructed with Si₃N₄ (silicon nitride). Silicon nitride does not exhibit any appreciable electro-optic effect and does not accommodate the generation of plasma-dispersion. However, the silicon nitride as the core 10 may allow for a low-loss propagation of the guided mode 20.

In the rest of the specification, the concept will be further described by way of examples comprising a waveguide with a Si₃N₄ (silicon nitride) as the core 10 and a semiconductor layer as the active device 40.

FIG. 2a is a schematic that illustrates an exemplary embodiment of a vertical coupling structure.

A waveguide structure includes a waveguide core 120 or a waveguide layer 120. For the evanescent interaction, a guided mode travelling through the waveguide core 120 is coupled to an active layer 140 via a coupling layer 130 or interlayer oxide layer 130. For the transferred interaction, a guided mode travelling through the waveguide core 120 is coupled and transferred to an active layer 140 via a coupling layer 130 or interlayer oxide layer 130.

FIG. 2a shows two examples, 100-1 on the left panel and 100-2 on the right panel. However, these two are merely implementation examples of the concept described in FIG. 1. The cross section of the coupling structure 100 is not limited by these two examples.

Also, the extent of the structure 100-1, 100-2, in the y-direction is not bounded by the vertical lines on each side. Similarly, the extent of the structure 100-1, 100-2, in the z-direction is not bounded by the topmost and bottommost horizontal lines. These lines are merely for guidance.

In some implementations, as shown on the left panel 100-1, the waveguide core 120 may be embedded in a cladding layer 110 or a bottom oxide 110. In case the cross-section of the waveguide core 120 is rectangular, the top surface of the waveguide core 120 may be exposed from the cladding layer 110. The coupling layer 130 and the active layer 140 are disposed as a plane parallel to the substrate or the xy-plane.

In some implementations, as shown on the right panel 100-2, the waveguide core 120 may be disposed on the cladding layer 110 or the bottom oxide 110. In case the cross-section of the waveguide core 120 is rectangular, the three sides of the waveguide core 120, the top surface and two side surfaces may be exposed from the cladding layer 110 and the bottom surface of the cross-section of the waveguide core 120 may be in contact with the cladding layer 110. The coupling layer 130 and the active layer 140 are disposed around the contour of the waveguide core 120.

The waveguide structure formed by the cladding layer 110 and the waveguide core 120 can be in any other forms feasible for the structure, 100-1, 100-2. For example, the shape of the cross-section of the waveguide core 120 may not be a rectangular shape and of any of the geometry discussed in FIG. 1.

The thickness of the waveguide core 120, in z-direction, may be between 10 nm and 2.5 μm. The examples of the material of the waveguide core 120 may include silicon nitride (SiₓN_{y}) with different stoichiometry and hydrogenated silicon nitride. The waveguide core 120 may be deposited using one or more of PECVD, sputtering or LPCVD techniques.

The examples of the material of the cladding layer 110 include one or more of silicon dioxide (SiO₂), silicon oxynitride (SiON) or aluminium oxide (Al₂O₃). The cladding layer 110 may be deposited using one or more of PECVD, LPCVD or via the thermal oxidation of a silicon substrate.

In some implementations, the active layer 140 as a photodetector may comprise semiconductor such as Si, Ge, InP, GaAs, InGaAs, InAlGaAs and combinations thereof.

In some implementations, the active layer 140 as an EO modulator may comprise semiconductor materials such as Si, Ge, InP, GaAs, InGaAs, InAlGaAs and combinations thereof.

In some implementations, the active layer 140 as an EO modulator may comprise electro-optic materials such as LiNbO₃, BaTiO₃, LiTaO₃, KTP, BBO or an electro-optic polymer.

Although not shown in the Figures, the active layer 140 may be electrically connected to auxiliary components to serve the intended purpose. For example, in order for the active layer 140 to function as a photodetector, the active layer 140 may comprise an InP intrinsic layer to act as light absorbing material. In such case, layer 140 may be positioned as shown in the left panel 100-1 of FIG. 2a. In this case, electrical junctions may be formed to extract the carriers generated in the active layer 140 and placed on the regions far from the optical mode 170 to reduce parasitic absorption due to dopants. For another example, in order for the active layer 140 to function as an EO modulator, the active layer 140 may comprise a low-doped or non-intentionally doped silicon layer connected with doped junctions to act as a PIN diode.

In order to minimize optical losses, the doped silicon regions can be placed far from the optical mode 170 and outside a coupling region, which will be described in FIG. 2b. This however can impact electrical losses as a larger intrinsic silicon region can lead to a larger electrical resistance. Therefore, a trade-off between electrical losses and optical losses might lead to an implementation such that the doped silicon region see a small portion of the optical mode 170. In such case, a reduction of coupling losses is highly desirable to partially mitigate the increased optical propagation losses. A typical solution is to form the intrinsic silicon layer such that it includes a horizontal tapering to improve coupling losses to and from the coupling layer 130. In addition, the coupling layer 130 may be tapered down and interrupted to maximize mode overlap to the active layer 140, as will be explained in more detail in FIGS. 2b and 2c.

The gap between the waveguide core 120 and the active layer 140 is controlled by the thickness of the coupling layer 130.

In some implementations, the thickness the coupling layer 130 may be between 0.1 nm and 1500 nm. Due to fundamental material properties, there is always an interface, however small, that forms which has different composition than the waveguide core 120 or the active layer 140.

In some implementations, the material of the coupling layer 130 comprises SiO₂, Al₂O₃, SiON, AlN and combination thereof.

The coupling layer 130 is deposited directly on the waveguide structure including the cladding layer 110 and the waveguide core 120 such that the coupling layer 130 directly contacts the waveguide core 120. In the example of the left panel 100-1, the top side of the waveguide core 120 is in contact with the coupling layer 130. In the example of the right panel 100-2, the top side and the two side surfaces of the waveguide core 120 is in contact with the coupling layer.

In a coupling region 180, which will be discussed in detail in FIG. 2b, the active layer 140 is deposited to be in direct contact with the coupling layer 130. FIG. 2a only depicts the cross section of the coupling structure 100-1, 100-2 in the coupling region 180.

In a taper region 190-1, 190-2, which will also be discussed in detail in FIG. 2b, the active layer 140 is deposited on a top oxide layer 150. In this case, the top oxide layer 150 is deposited directly on the coupling layer 130 to be in between the coupling layer 130 and the active layer 140.

In some implementations, in the coupling region 180, the top oxide layer 150 is deposited on the active layer 140 as shown in FIG. 2a.

In some implementations, in the coupling region 180, the top oxide layer 150 shown in FIG. 2a may be absent and the top surface of the active layer 140 may be exposed to air or vacuum.

In some implementations, the top oxide layer 150 comprises an electro-optic polymer. The examples of the electro-optic polymer includes chromophores embedded into PMMA to form a silicon-organic hybrid modulator. In this case, the active layer 140 may be silicon or silicon-germanium.

The guided mode 170 is indicated by the circle with a dotted line. The guided mode 170 at least partially overlaps with the active layer through the coupling layer 130. The guided mode 170 travels into and out of the page, namely along the x-direction.

FIG. 2b is a schematic that illustrates an exemplary embodiment of a vertical coupling structure for evanescent interaction.

The coupling structure 100 describes the cross section along the vertical dotted line 101 of the coupling structure 100-1, 100-2 in FIG. 2a.

The coupling region 180 is interposed between two taper regions 190-1, 190-2. Alternatively, the coupling region 180 may be neighboured by only one taper region 190-1, 190-2.

The cladding layer 110 or the bottom oxide layer 110, the waveguide core 120 or the waveguide layer 120, the coupling layer 130 or the interlayer 130, and the active layer 140 are as described in FIG. 2a.

The top oxide layer 150 is patterned before depositing the active layer 140 such that in the coupling region 180, the top surface of the coupling layer 130 is exposed.

The active layer 140 is directly in contact with the coupling layer 130 in the coupling region 180.

The active layer 140 in the taper region 190-1, 190-2 is at an angle A1, A2 with respect to the plane of the active layer 140 in the coupling region 180.

The active layer 140 in the taper region is continuously connected to the active layer 140 in the coupling region.

In particular, in this embodiment, the waveguide core 120 is continuous.

The guided mode 170-1, 170-2 travels in the horizontal direction, namely along the x-direction in FIG. 2b, from the taper region 190-1 on the left to the coupling region 180, to the taper region 190-2 on the right. The direction of the propagation is taken to be in the positive x-direction, left to right. However, it is understood that the operation of the coupler structure 100 is reciprocal and the coupler structure 100 functions also with the guided mode 170-1, 170-2 launched from the left propagating to the right. Two dotted lined circles, 170-1, 170-2 are shown in FIG. 2b for illustration, one in the coupling region 180, the other in the taper region 190-1, 190-2.

In this specification, a first angle A1 will be defined as an angle of the active layer 140 at the interface between the coupling region 180 and the taper region 190-1 at which the guided mode 170-1, 170-2 enters or couples into the coupling region 180. A second angle A2 will be defined as an angle of the active layer 140 at the interface between the coupling region 180 and the taper region 190-2 at which the guided mode 170-1, 170-2 exits or couples out of the coupling region 180. Therefore, according to this definition, in the example of FIG. 2b, the propagation direction is from left to right, or in the negative x-direction.

In the taper region 190-1, 190-2, the interaction between the active layer 140 and the guided mode 170-1 is negligible, except the portion of the taper region 190-1, 190-2 near the coupling region 180.

In the taper region 190-1 near the coupling region 180 and on the left to the coupling region 180, the interaction between the active layer 140 and the guided mode 170-1 gradually increases as it approaches the coupling region 180, where the interaction is maximised. Similarly, the interaction between the active layer 140 and the guided mode 170 gradually decreases as it leaves the coupling region 180 towards the taper region 190-2 on the right to the coupling region 180.

In the coupling region 180, there is finite interaction between the active layer 140 and the guided mode 170-2, as explained in FIG. 2a.

In some implementations, in the coupling region 180, the width, in the y-direction, normal to the propagation direction and parallel to the substrate, of the waveguide core 120 may be tapered continuously down towards the middle of the coupling region 180 and tapered continuously up towards the end of the coupling region 180 to optimise the coupling efficiency.

In some implementations, outside the vertical coupling structure 100, including two of the taper regions 190-1, 190-2 interposing the coupling region 180 the active layer 140 may be not present. Alternatively, outside the vertical coupling structure 100, the active layer 140 may be present. However, in this case, the interaction between the guided mode 170 travelling along the waveguide core 120 and the active layer 140 is negligible.

Compared to the case without any taper region the coupling structure 100 mitigates the spurious scattering of the guided mode coupling in and out of the coupling region 180. This allows for an additional degree of freedom to control coupling losses.

The length of the coupling region, the extent in x-direction, is determined as described in FIG. 1, depending on the purpose of the coupling structure 100 and determined to maximise the balance between the degree of interaction and the degree of loss.

In some implementations, the first angle A1 and the second angle A2 between the active layer 140 in the coupling region 180 and the active layer 140 in the taper region 190-1, 190-2 may be the same on both boundaries between the coupling region 180 and the taper region 190-1, 190-2. In this case, the first angle A1 and the second angle A2 may be optimised to minimize transmission losses. The transmission losses are defined to be the sum of the in-coupling loss from re the sum of the in-coupling losses from the waveguide core 120 and the coupling layer 130 to the active layer 140 and the out-coupling losses from the active layer 140 to the waveguide core 120 and the coupling layer 130.

In some implementations, the first angle A1 and the second angle A2 between the active layer 140 in the coupling region 180 and the active layer 140 in the taper region 190-1, 190-2 may be different at each boundary between the coupling region 180 and the taper region 190-1, 190-2.

FIG. 2c is a schematic that illustrates an exemplary embodiment of a vertical coupling structure for transferred interaction.

The coupling structure 100 describes the cross section along the vertical dotted line 101 of the coupling structure 100-1, 100-2 in FIG. 2a.

The coupling region 180 is interposed between two taper regions 190.

Alternatively, the coupling region 180 may be neighboured by only one taper region 190.

The cladding layer 110 or the bottom oxide layer 110, the coupling layer 130 or the interlayer 130, and the active layer 140 are as described in FIG. 2a. In the taper region 190-1, 190-2, the waveguide core 120 or the waveguide layer 120 is as described in FIG. 2b. In the coupling region 180, the waveguide core 120 or the waveguide layer 120 is arranged to taper down to a transfer region 181. In the transfer region 181, the waveguide layer 120 is absent and the space is filled with the coupling layer 130. In this embodiment, within the coupling region 180, the waveguide core vanishes for a fixed distance.

The top oxide layer 150 is patterned before depositing the active layer 140 such that in the coupling region 180, the top surface of the coupling layer 130 is exposed. The active layer 140 is directly in contact with the coupling layer 130 in the coupling region 180.

The active layer 140 in the taper region 190-1, 190-2 is at an angle A1, A2 with respect to the plane of the active layer 140 in the coupling region 180.

The active layer 140 in the taper region is continuously connected to the active layer 140 in the coupling region.

The guided mode 170-1, 170-2 travels in the horizontal direction, namely along the x-direction in FIG. 2b. Three dotted lined circles, 170-1, 170-2, 170-3 are shown in FIG. 2c for illustration, one in the transfer region 181, the other two in the taper region 190-1, 190-2.

The first angle A1 and the second angle A2 are as described in FIG. 2b.

and the guided mode 170-1 is negligible, except the portion of the taper region 190-1, 190-2 near the coupling region 180.

In the taper region 190-1, 190-2 near the coupling region 180, the interaction between the active layer 140 and the guided mode 170-1 gradually increases as it approaches the coupling region 180, where the interaction is maximised. Similarly, the interaction between the active layer 140 and the guided mode 170 gradually decreases as it leaves the coupling region 180 towards the taper region 190-1, 190-2.

In the coupling region 180 and outside the transfer region 181, the waveguide 10) layer 120 and the active layer 140 are coupled via the coupling layer 130 and forms a directional coupler. The distance between the start of the coupling region 180 and the start of the transfer region 181 and the first angle A1 are determined such that the transfer of the guided mode 170-1 in the waveguide layer 120 to the guided mode 170-2 in the active layer 140 is maximised. Within the transfer region 181, the waveguide layer 120 is absent and the guided mode 170-2 is guided along the active layer 140. Within the transfer region 181, the waveguide layer 120 is absent and the guided mode 170-2 is guided along the active layer 140.

In some implementations, the distance between the end of the coupling region 180 and the end of the transfer region 181 and the second angle A2 are determined such that the transfer of the guided mode 170-2 in the active layer 140 to the guided mode 170-3 in the waveguide layer 120 to is maximised.

In some implementations, since the active layer 140 is formed as a waveguide supporting a guided mode 170-2, the active layer 140 in the taper regions 190-1, 190-2 may be used to transfer the guided mode 170-2 to outside the vertical coupling structure 100.

Compared to the coupler structure 100 for evanescent interaction shown in FIG. 2b, in the coupler structure 100 for transfer interaction as shown in FIG. 2c, the efficiency in the electro-optic modulation or the photodetection may be greater. This is because the guided mode 170-2 is transferred entirely and guided along the active layer 140 with the centre of the guided mode 170-2 within the active layer 140. In some implementations, in order to reduce scattering loss, the width of the waveguide layer may be tapered down starting from the start of the interaction region 180 to the start of the transfer region 181.

In some implementations, in order to reduce scattering loss, the width of the waveguide layer may be tapered up starting from the end of the transfer region 181 to the start of the interaction region 180.

The length of the coupling region 180 and the length of transfer region 181, the extent in x-direction, are determined as described in FIG. 1, depending on the purpose of the coupling structure 100 and determined to maximise the balance between the degree of interaction and the degree of loss.

In some implementations, the first angle A1 and the second angle A2 between the active layer 140 in the coupling region 180 and the active layer 140 in the taper region 190 may be the same on both boundaries between the coupling region 180 and the taper region 190. In this case, the first angle A1 and the second angle A2 may be optimised to minimize transmission losses. In the transferred interaction case, the efficiency is defined to be the ratio of the power of the guided mode 170-2 within the active layer 140 in the transfer region 181 to the power of the guided mode 170-1, 170-3 within the waveguide mode 120 in the taper region 190-1, 190-2.

In some implementations, the first angle A1 and the second angle A2 between the active layer 140 in the coupling region 180 and the active layer 140 in the taper region 190-1, 190-2 may be different at each boundary between the coupling region 180 and the taper region 190-1, 190-2. For example, in the example of FIG. 2c, the coupling structure 100 may be used as a directional coupler with a view to transfer all or part of the guided mode 170-2 within the active layer 140 in the transfer region 181 to a photonic layer above the top oxide layer 150, which is not depicted in FIG. 2c. In this case, the power of the guided mode 170-2 may be split between the active layer 140 and the waveguide core 120 as the guided mode 170-2 exits the coupling region 180. In this case, the first angle A1 may be optimised to minimise the transmission loss for the optical mode 170-1 entering the coupling region 180 and the second angle A2 may be optimised to achieve a desired degree of optical splitting at the boundary of the second angle A2.

FIGS. 2b and 2c show that the top surface of the active layer 140 is exposed to air or vacuum. However, further top oxide layer 150 may be deposited over the active layer 140. For example, this deposition may comprise electrooptic polymer or additional polymer cladding.

Although not shown in the FIGS. 2a, 2b and 2c, lateral tapering of the active layer 140 can be combined with the vertical coupling structure 100 to further reduce the scattering losses.

The top oxide 150, in particular the angled profile, is etched by reactive ion etching with a mixture of CxFy, H2 and/or CxHyFz gas precursors in a ratio that allows for a tapered angle to be achieved. A gray-scale lithography method and/or photoresist annealing method can be used to form an angled photoresist mask. The angled profile is subsequently transferred via reactive ion etching. A resist profile can be made such that the resulted etching profile has the desired angle. Small angles can typically be achieved via grayscale lithography in the resist, which allows for etchings with small angles profile in the top oxide layer 150.

Alternatively, a tilted angle Ion Beam Etcher can be used, which allows for an angled etch with high accuracy on the angle. In this case, a photoresist mask is typically deposited on top of layer 150. The photoresist mask is then patterned by lithography to protect the areas outside regions occupied by the coupling structure 100. Then the substrate is loaded into an Ion Beam Etcher and exposed to the etching chamber such that the ions etching the exposed portions of top oxide layer 150 etch with a desired angle. The deposition and patterning of the photo resist mask can be repeated to produce different angles of the first angle A1 and the second angle A2 on the same substrate.

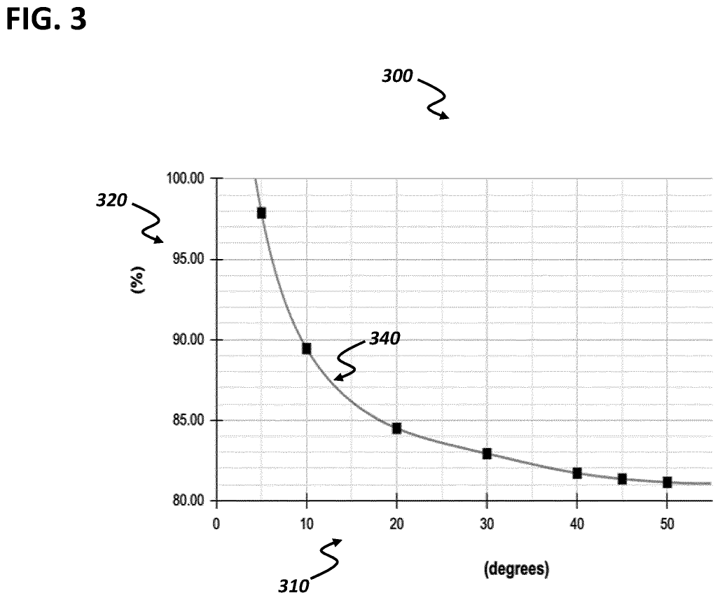

FIG. 3 shows a simulation result of coupling efficiency.

A graph 300 shows a simulation result of coupling efficiency based on the implementation shown in FIG. 2c, with a horizontal axis 310 representing the first angle A1 and the second angle A2 in degrees, assumed to be identical and a vertical axis 320 representing the coupling efficiency in percentage.

The coupling efficiency or the power coupling efficiency is defined to be the ratio of the input power of the guided mode 170-1 in the taper region 190-1 to the output power of the guided mode 170-3 in the taper region 190-2 after going through the coupling region 180.

The waveguide layer 120 is assumed to be silicon nitride. The thickness of the waveguide layer 120 is set to be 800 nm. The coupling layer 130 is assumed to be silicon dioxide. The thickness of the coupling layer 130 is set to be 100 nm. The width of the waveguide layer 120 in the taper regions 190-1, 190-2 is set to be 800 nm. Within the coupling region, the width of the waveguide layer 120 is tapered down from the start of the coupling region 180 to the start of the transfer region 181 to the width of 200 nm. From the end of the transfer region 181 where the width of the waveguide layer 120 is set to be 200 nm, the width of the waveguide layer 120 is tapered up to 800 nm at the end of the coupling region 180. The active layer is assumed to be silicon. The thickness of the active layer 140 is set to be 40 nm.

A curve 340 shows that when the first angle A1 and the second angle A2 are less than 10 degrees, it is possible to achieve coupling losses less than 10%. The curve 340 shows that 89.4% power coupling efficiency is achievable for first and second angles A1, A2 at 10 degrees.

For the embodiment of FIG. 2b, compared to the case where the active layer 140 only includes a section in the coupling region 180 without any active layer 140 outside the coupling region 180, improvement in the coupling efficiency begins when the first angle A1 and/or the second angle A2 are smaller than 60 degrees.

For other high index contrast waveguides with a similar index contrast to that of silicon nitride/silicon dioxide, improvement in coupling efficiency may be obtained when the first angle A1 and/or the second angle A2 are smaller than 30 degrees. For low index contrast waveguides such as glass cladding with doped glass core, the first angle A1 and/or the second angle A2 needs to be in general smaller than the case of high index contrast waveguides.

The embodiments of the invention shown in the drawings and described hereinbefore are exemplary embodiments only and are not intended to limit the scope of the invention, which is defined by the claims hereafter. It is intended that any combination of non-mutually exclusive features described herein are within the scope of the present invention.

### STATEMENT OF FINANCIAL SUPPORT

The project leading to this application has received funding from the European Union's Horizon 2020 research and innovation programme under grant agreement No. 954530.

1. A coupling structure, comprising:
a waveguide core layer supporting a guided mode; and
an active layer disposed above the waveguide core layer;
wherein in the coupling region, the guided mode is coupled to the active layer, and
wherein the active layer outside the coupling region is angled with respect to the active layer in the coupling region such that a distance between the waveguide core layer and the active layer gradually increases away from the coupling region.

2. The coupling structure of claim 1, further comprising:
a coupling layer disposed on the waveguide core layer and below the active layer.

3. The coupling structure of claim 2,
wherein in the coupling region, a thickness of the coupling layer is such that the guided mode is evanescently coupled to the active layer.

4. The coupling structure of claim 3,
wherein a bottom surface of the coupling layer is in contact with the waveguide core layer, and
wherein in the coupling region, a top surface of the coupling layer is in contact with the active layer.

5. The coupling structure of claim 1,
wherein in the coupling region, the waveguide layer and the active layer are coupled such that the guided mode is supported by the active layer in the coupling region and the guided mode is supported by the waveguide core layer outside the coupling region.

6. The coupling structure of claim 5,
wherein in the coupling region, a width of the waveguide layer is tapered down towards a centre of the coupling region.

7. The coupling structure of claim 5,
wherein the waveguide core layer comprises an in-coupling layer, an out-coupling layer and a gap between the in-coupling layer and the out-coupling layer,
wherein the gap is in the coupling region, and
wherein the guided mode is coupled to the active layer above the gap in the coupling region.

8. The coupling structure of claim 7,
wherein the out-coupling layer and the active layer are arranged such that the guided mode in the coupling region in the active layer is coupled to the out-coupling layer.

9. The coupling structure of claim 7,
wherein the out-coupling layer and the active layer are arranged such that at least part of the guided mode in the coupling region in the active layer is coupled to the active layer outside the coupling region.

10. The coupling structure of claim 1,
wherein the active layer outside the coupling region is at a first angle with respect to the active layer in the coupling region, and
wherein the first angle is less than 30 degrees.

11. The coupling structure of claim 1,
wherein the active layer is configured as a photodiode for detecting the guided mode supported by the waveguide core layer.

12. The coupling structure of claim 1,
wherein the active layer is configured as an electro-optic modulator for modulating amplitude and/or phase of the guided mode supported by the waveguide core layer.

13. The coupling structure of claim 12,
wherein the active layer comprises an electro-optic material, such as LiNbO₃, BaTiO₃, LiTaO₃, KTP, BBO or an electro-optic polymer.

14. The coupling structure of claim 11,
wherein the active layer comprises a semiconductor, such as Si, Ge, InP, GaAs, InGaAs, InAlGaAs and combinations thereof.

15. The coupling structure of claim 1, further comprising:
a top layer disposed on the coupling layer outside the coupling region, forming a slope towards the coupling region, and
wherein the active layer is disposed on the top layer outside the coupling region such and on the coupling layer in the coupling region.
